(19) United States
(12) Patent Application Publication
(10) Pub. No.: US 2026/0079865 A1
(43) Pub. Date: Mar. 19, 2026

(54) PIN CONFIGURATION OWNERSHIP FOR A MICROCONTROLLER

(71) Applicant: Microchip Technology Incorporated, Chandler, AZ (US)

(72) Inventors: Stephen Bowling, Chandler, AZ (US); Manivannan Balu, Bangalore (IN); Peter Reen, Gilbert, AZ (US); Igor Wojewoda, Tempe, AZ (US)

(73) Assignee: Microchip Technology Incorporated, Chandler, AZ (US)

(21) Appl. No.: 18/960,944

(22) Filed: Nov. 26, 2024

(30) Foreign Application Priority Data
Sep. 17, 2024 (IN) 202411070266

(51) Int. Cl. G06F 13/20

(52) U.S. Cl. CPC G06F 13/20; G06F 2213/40

(57) ABSTRACT

A method to configure an input/output pad that controls a pin of a microcontroller via a first level multiplexer and a central processing unit, grant exclusive configuration ownership of the input/output pad, via a second level multiplexer, to a pin configuration function, and configure exclusively the input/output pad via the pin configuration function. A microcontroller with an input/output pad, a pin controlled by the input/output pad, a first level control circuit to configure the input/output pad, and a second level control circuit to exclusively configure the input/output pad.

### RELATED PATENT APPLICATION

This application claims priority to commonly owned Indian Patent Application No. 202411070266 filed Sep. 17, 2024, the entire contents of which are hereby incorporated by reference for all purposes.

### TECHNICAL FIELD

The present disclosure relates to microcontrollers and, in particular, to general purpose input/output ports in microcontrollers.

### BACKGROUND

A general purpose input/output (GPIO) port is generally understood as a parallel digital input/output port of a microcontroller. With current microcontrollers, GPIO functions are organized by ports (A, B, C, . . . N), with each port having a set of registers input/output registers to control it. Furthermore, to control whether the port is used for digital input or digital output, a direction register such as a tri-state control register can be provided. Increasingly, microcontrollers are “low pin count”devices.

When, as a consequence, a large number of peripherals are multiplexed onto each pin, it is unlikely that more than one to three GPIO functions will be available on any given port, once a user allocates the pins for dedicated pin functions, such as UART (universal asynchronous receiver/transmitter), SPI (serial peripheral interface), I2C (inter-integrated circuit), without limitation. This means that when the user wants a coherent (atomic, for example, the ability to read or write the set of GPIO pins with a single CPU instruction) set of GPIO pins with more than a couple of pins, they access multiple registers to drive data to those pins or sample data from those pins. This leads to limitations, such as the inability to drive all GPIO pins high at the same time, or to sample all GPIO pins at the same time.

In the typical MCU (microcontroller unit) application, the MCU is in a reset state at the moment the system is powered up. All MCU I/O (input/output) pins are tristated and initialization software is run on the MCU to configure the I/O pins and the peripherals that will control each pin. The initialization software takes some amount of time to run, and therefore, there is a significant delay between the time that power is valid in the system and the time at which the MCU I/O pins can start to control system functions. If a soft reset of the MCU occurs, such as a watchdog or MCLR (master clear) event, then the I/O pins will again become inactive until initialization software is run.

Because of this startup delay, external components may be provided on the PCB (printed circuit board), which provide fixed functions. These fixed functions could include logic such as AND/OR gates, programmable logic such as a PAL (programmable array logic) or FPGA (field-programmable gate array), or analog functions such as a comparator, op-amp or DAC (digital-to-analog converter). These fixed functions may serve a protection role in the application that is intended to remain active independently of the MCU software and reset state. In the case of analog functions, an op-amp may provide gain on a sensor signal, a comparator to monitor a sensor signal, or a DAC to provide a voltage reference.

Another problem arises when the I/O pin configuration is subject to software errors. If code accidentally writes certain register locations, the I/O pin function could be accidentally changed.

There is a need for a microcontroller that provides a fixed or exclusive I/O pin configuration.

### SUMMARY OF THE INVENTION

Aspects provide a method comprising: configuring an input/output pad that controls a pin of a microcontroller via a first level multiplexer and a central processing unit; granting exclusive configuration ownership of the input/output pad, via a second level multiplexer, to a pin configuration function; and configuring exclusively the input/output pad via the pin configuration function.

According to an aspect, there is provided a method as in the preceding paragraph, wherein the pin configuration function comprises a logic function, wherein the logic function is configurable or fixed.

According to an aspect, there is provided a method as in one of the preceding two paragraphs, wherein the pin configuration function comprises an analog function.

According to an aspect, there is provided a method as in one of the preceding three paragraphs, comprising controlling the second level multiplexer via flash configuration logic.

According to an aspect, there is provided a method as in one of the preceding four paragraphs, comprising: granting exclusive configuration ownership of the input/output pad, via the second level multiplexer, to a third level multiplexer; granting exclusive configuration ownership of the input/output pad, via the third level multiplexer, to an outside safe/secure control source; configuring exclusively the input/output pad via the an outside safe/secure control source.

According to an aspect, there is provided a method as in one of the preceding five paragraphs, wherein the outside safe/secure control source comprises a Hardware Security Module.

According to an aspect, there is provided a method as in one of the preceding six paragraphs, wherein the outside safe/secure control source comprises a Functional Safety Controller.

An aspect provides a device comprising: a microcontroller comprising a central processing unit, an input/output pad, and a pin controlled by the input/output pad; a first level multiplexer associated with the central processing unit to configure the input/output pad; a pin configuration function to exclusively configure the input/output pad; and a second level multiplexer to assign configuration ownership of the input/output pad to either the first level multiplexer or the pin configuration function.

According to an aspect, there is provided a device as in the preceding paragraph, wherein the pin configuration function comprises a logic function, wherein the logic function is configurable or fixed.

According to an aspect, there is provided a device as in one of the preceding two paragraphs, wherein the pin configuration function comprises an analog function.

According to an aspect, there is provided a device as in one of the preceding three paragraphs, comprising a flash configuration logic to control the second level multiplexer.

According to an aspect, there is provided a device as in one of the preceding four paragraphs, comprising a third level multiplexer and an outside safe/secure control source, wherein the second level multiplexer is to grant exclusive configuration ownership of the input/output pad to the third level multiplexer, wherein the third level multiplexer is to grant exclusive configuration ownership of the input/output pad to the outside safe/secure control source, and wherein the outside safe/secure control source is to exclusively configure the input/output pad.

According to an aspect, there is provided a device as in one of the preceding five paragraphs, wherein the outside safe/secure control source comprises a Hardware Security Module.

According to an aspect, there is provided a device as in one of the preceding six paragraphs, wherein the outside safe/secure control source comprises a Functional Safety Controller.

An aspect provides a microcontroller comprising: an input/output pad; a pin controlled by the input/output pad; a first level control circuit to configure the input/output pad; and a second level control circuit to exclusively configure the input/output pad.

According to an aspect, there is provided a microcontroller as in the preceding paragraph, wherein the second level control circuit comprises a logic function or an analog function, wherein the logic function is configurable or fixed.

According to an aspect, there is provided a microcontroller as in one of the preceding two paragraphs, wherein the second level control circuit comprises: a second level multiplexer; and a flash configuration logic to control the second level multiplexer.

According to an aspect, there is provided a microcontroller as in one of the preceding three paragraphs, comprising a third level control circuit to exclusively configure the input/output pad when the second level control circuit grants to the third level control circuit exclusive control ownership of the input/output pad.

According to an aspect, there is provided a microcontroller as in one of the preceding four paragraphs, wherein the third level control circuit comprises a third level multiplexer, flash configuration logic, and an outside safe/secure control source, and wherein the outside safe/secure control source is to exclusively configure the input/output pad.

According to an aspect, there is provided a microcontroller as in one of the preceding five paragraphs, wherein the outside safe/secure control source comprises a Hardware Security Module or a Functional Safety Controller.

### BRIEF DESCRIPTION OF THE DRAWINGS

The figures illustrate examples of microcontrollers that provide fixed or exclusive I/O pin configurations so that other CPU sources may not control the pin function.

FIG. 1 shows a block diagram of a microcontroller circuit for controlling an input/output pad and pin, wherein the microcontroller circuit has a second level pad ownership multiplexer and a configurable logic function.

FIG. 2 shows a block diagram of a microcontroller circuit for controlling an input/output pad and pin, wherein a second level pad ownership multiplexer grants pin ownership to an analog input function to configure the input/output pad so that digital buffers on the pin are disabled and an analog pass switch is enabled.

FIG. 3 shows a block diagram of a microcontroller circuit for controlling an input/output pad and pin, wherein a second level pad ownership multiplexer grants ownership to any one of a first CPU, a second CPU, a configurable logic function, or an analog input function.

FIG. 4 shows a block diagram of a microcontroller circuit for controlling an input/output pad and pin, wherein a second level pad ownership multiplexer grants pin ownership to any one of a first CPU, a second CPU, a configurable logic function, or an analog input function, and a third level multiplexer assigns ownership control to an outside safe/secure control source.

FIG. 5 shows a flow chart of a method to assign an owner of the I/O pin exclusive control of the output state of the pin.

FIG. 6 shows a block diagram of a microcontroller comprising: an input/output pad; a pin controlled by the input/output pad; a first level control circuit to configure the input/output pad; and a second level control circuit to exclusively configure the input/output pad.

FIG. 7 is a block diagram of circuitry to implement various functions, operations, acts, processes, and/or methods to assign an owner of the I/O pin exclusive control of the output state of the pin.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect, there is provided a second level multiplexer between the MCU and the I/O pin. This added multiplexer allows another source, besides the MCU and associated software, to have ownership, i.e., exclusive control, of the I/O pin. Furthermore, there can be an optional third multiplexer that determines the source that configures the pin ownership. The pin ownership configuration source could be an on-chip state machine, an external source, or a secure element such as a Hardware Security Module. The owner of the I/O pin may determine the I/O pin configuration - specifically whether the pin is analog or digital, digital input or output, whether pull up resistors are enabled, pin slew rate, and many other parameters, without limitation.

One aspect is to provide exclusive I/O pin ownership. In present multi-core microcontroller devices, flash configuration may be used to assign I/O pin control ownership to one CPU subsystem or the other. Flash configuration may consist of an array of fixed data in non-volatile memory which is automatically written into configuration holding registers at power-up by a state machine dedicated to this task. Note that flash configuration is merely an example method that could be used at power up. This method is commonly used to emulate ROM settings or real fuses that can be permanently set to a value.

The flash configuration may be automatically loaded after a power-up event and gives one CPU subsystem pin ownership, i.e., the ability to control the output drive of each I/O pin. The other CPU subsystem can read and monitor the I/O pin state, but it cannot drive the pin.

This pin ownership concept can be extended from a CPU ownership assignment to other owners. Based on the flash configuration settings, the ownership of the pin could also be assigned to logic or analog functions. The logic and analog functions could be fixed functions, or they could have configuration options that are also loaded from the flash configuration at power-up.

The assigned owner of the I/O pin may have exclusive control of the output state of the pin. All of the other non-owners can monitor the pin state, but cannot affect the state. The pin ownership concept is also extended to pins that serve as inputs to logic or analog functions. Once ownership is assigned to an input pin, the non-owners cannot do anything to the input pin configuration that would affect the integrity of the input signal. If a logic function is granted pin ownership and configures the input pin as a digital ST input buffer, no non-owner can override this configuration. If an analog input function is granted pin ownership and configures digital buffers on the pin to be disabled and an analog pass switch is enabled, then no non-owner can override this configuration.

The flash configuration can also be used to configure peripheral settings to support the I/O pin ownership. For example, the flash configuration could do any of the following: (1) enable an op-amp that is connected to the pins; (2) enable a DAC connected to the pins and set the reference output voltage; (3) enable a simple logic function, such as an AND gate or an OR gate; and (4) configure and enable a more complex logic function, such as a FPGA or some other form of configurable logic.

An I/O pad on a microcontroller typically has several control inputs and paths for data: (1) enable for the digital output driver; (2) digital input data for the pad output driver; (3) pull-up or pull-down resistor enables; (4) enables for ST input buffer, I2C input buffer, without limitation; (5) enables for analog switches associated with the pad. These control and data inputs are typically under full control of the application software and there are multiplexers at the pad inputs to determine which peripheral associated with the MCU has control of the pad.

Aspects provide a second level multiplexer between the first level CPU configuration multiplexers and the pad inputs. This second level multiplexer may be called an ownership multiplexer. This second level multiplexer can isolate the pad control to either a specific configuration source or even a fixed configuration source.

Control of the second level ownership multiplexer could be assigned to the flash configuration states machine discussed earlier. Alternatively, configuration could be assigned to a trusted external source such as a Hardware Security Module.

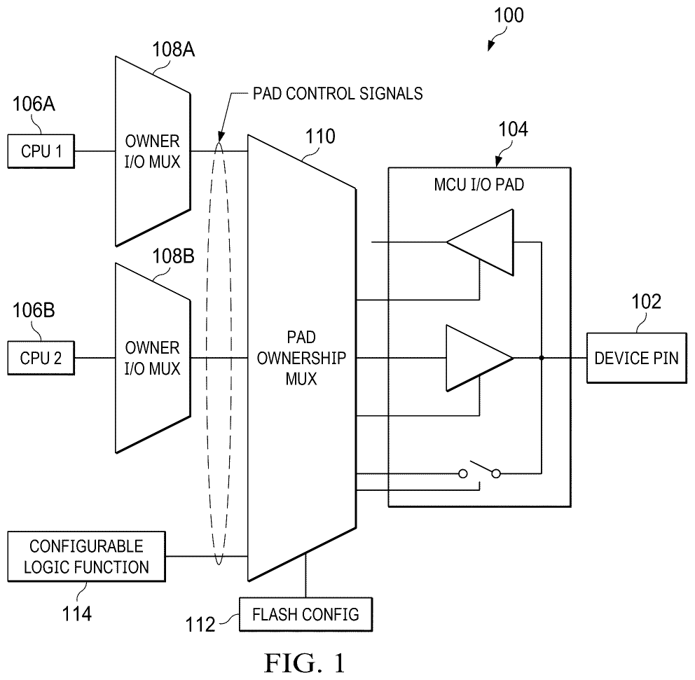

FIG. 1 shows a block diagram of a microcontroller circuit 100 for controlling an input/output pad and pin. A pin 102 is connected to an input/output pad 104. The input/output pad 104 may provide via the pin 102 a controlled digital/CMOS input path, a CMOS/digital output path, an uncontrolled analog path, a controlled analog path, or weak pulls. Two different CPUs, 106A and 106B, have dedicated analog and digital functions added as pad control sources. These sources, when selected, may have control of the pad configuration inputs via first level owner I/O multiplexers 108A and 108B. A second level pad ownership multiplexer 110 has additional pad control sources added to it that allows for different control sources to configure the input/output pad 104. The microcontroller circuit 100 may include flash configuration logic 112, which may be associated with a CPU system inside the MCU, to control the second level pad ownership multiplexer 110. In the embodiment shown in FIG. 1, the microcontroller circuit 100 comprises a configurable logic function 114. The flash configuration logic 112 may allow the second level pad ownership multiplexer 110 to grant pin ownership to any one of CPU 106A, CPU 106B, and configurable logic function 114.

The pin 102 is configured by the fixed peripheral function that is assigned to the pin 102 via the flash configuration 112. A pad ownership mux 110 ensures that a configurable logic function 114 has exclusive control of the pin 102 instead of the CPUs 106A and 106B, which could also control the pin 102. It is like a protection function that keeps the pin 102 assigned to a specific peripheral and avoids errant software from changing the pin function. The Flash config 112 is not a source into the pad ownership multiplexer 110, it controls the multiplexer input. The specific pad configuration may come from the fixed peripheral, analog function, or logic function that was assigned to the pad 104.

If the second level pad ownership multiplexer 110 to grants exclusive pin ownership to the configurable logic function 114 and the configurable logic function 114 exclusively configures the pin 102 as a digital ST input buffer, no non-owner can override this exclusive configuration. This solution may allow the peripheral assigned to the pad and the configuration of the pad to remain in a fixed configuration, once power is applied to the system. Because the exclusive configuration is fixed, a safety important application may remain functional in the case of power outage or other interruption. The exclusive configuration of the pin function can remain permanent or fixed and not affected by an improper code execution. The function may be disrupted in the case of a power failure. However, it would be immune to events such as CPU watchdog resets, lost code, without limitation. The Flash configuration may be made to be stable through device soft reset events. These resets may include all things that reset the CPU, except for loss of power.

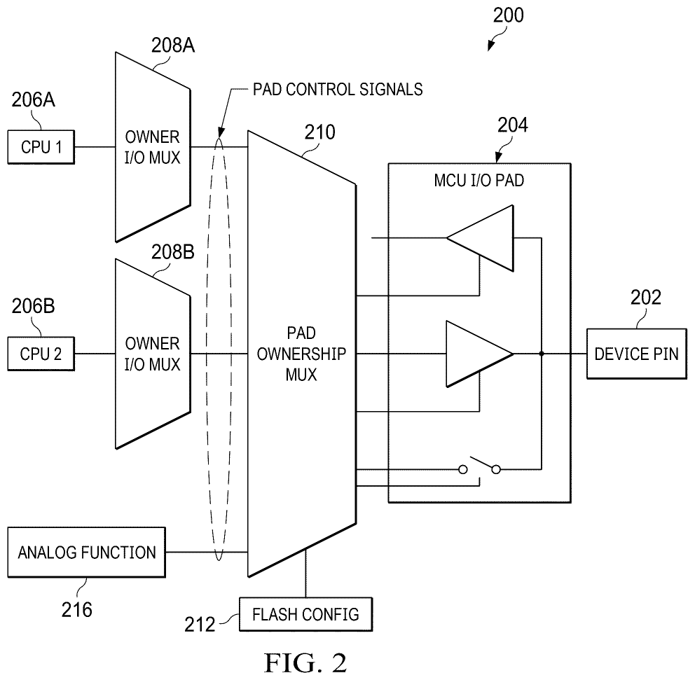

FIG. 2 shows a block diagram of a microcontroller circuit 200 for controlling an input/output pad and pin. A pin 202 is connected to an input/output pad 204. The input/output pad 204 may provide via the pin 202 a controlled digital/CMOS input path, a CMOS/digital output path, an uncontrolled analog path, a controlled analog path, or weak pulls. Two different CPUs, 206A and 206B, have dedicated analog and digital functions added as pad control sources via first level owner I/O multiplexers 208A and 208B. A second level pad ownership multiplexer 210 has additional pad control sources added to it that allows for different control sources to configure the input/output pad 204. The microcontroller circuit 200 may include flash configuration logic 212, which may be associated with a CPU system inside the MCU, to control the second level pad ownership multiplexer 210. In the embodiment shown in FIG. 2, the microcontroller circuit 200 comprises an analog input function 216. The flash configuration logic 212 may allow the second level pad ownership multiplexer 210 to grant pin ownership to any one of CPU 206A, CPU 206B, and analog input function 216. If the second level pad ownership multiplexer 210 to grants exclusive pin ownership to the analog input function 216 and the analog input function 216 exclusively configures the input/output pad 204 so that all digital buffers on the pin 202 are disabled and a certain analog pass switch is enabled, then no non-owner can override this exclusive configuration.

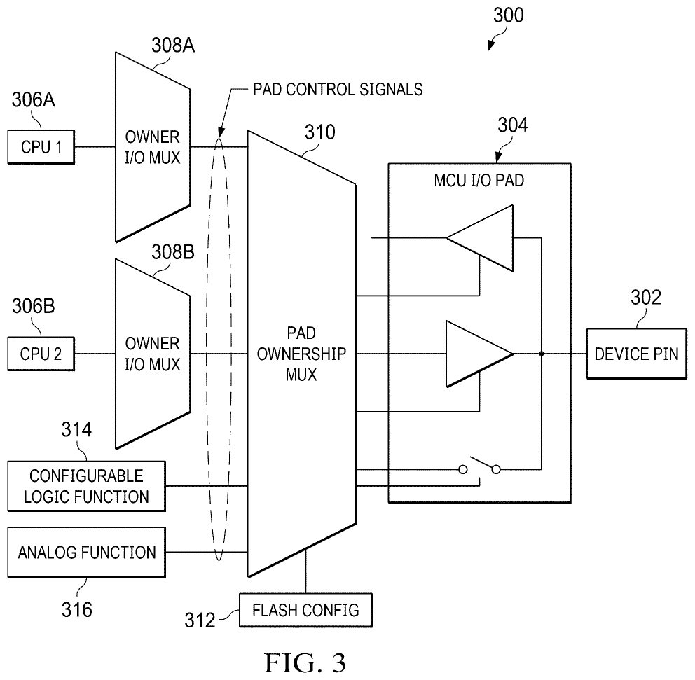

FIG. 3 shows a block diagram of a microcontroller circuit 300 for controlling an input/output pad and pin. A pin 302 is connected to an input/output pad 304. The input/output pad 304 may provide via the pin 302 a controlled digital/CMOS input path, a CMOS/digital output path, an uncontrolled analog path, a controlled analog path, or weak pulls. Two different CPUs, 306A and 306B, have dedicated analog and digital functions added as pad control sources via first level owner I/O multiplexers 308A and 308B. A second level pad ownership multiplexer 310 has additional pad control sources added to it that allows for different control sources to configure the input/output pad 304. The microcontroller circuit 300 may include flash configuration logic 312, which may be associated with a CPU system inside the MCU, to control the second level pad ownership multiplexer 310. In the embodiment shown in FIG. 3, the microcontroller circuit 300 comprises a configurable logic function 314 and an analog input function 316. The flash configuration logic 312 may allow the second level pad ownership multiplexer 310 to grant pin ownership to any one of CPU 306A, CPU 306B, configurable logic function 314, and analog input function 316. If the second level pad ownership multiplexer 310 to grants exclusive pin ownership to the configurable logic function 314 and the configurable logic function 314 exclusively configures the pin 302 as a digital ST input buffer, no non-owner can override this exclusive configuration. If the second level pad ownership multiplexer 310 to grants exclusive pin ownership to the analog input function 316 and the analog input function 316 exclusively configures the input/output pad 304 so that all digital buffers on the pin 302 are disabled and a certain analog pass switch is enabled, then no non-owner can override this exclusive configuration.

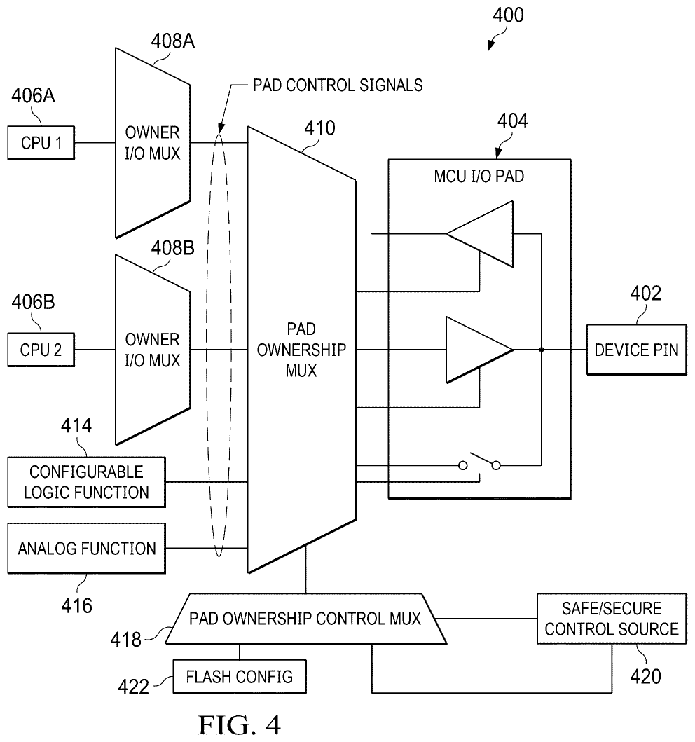

FIG. 4 shows a block diagram of a microcontroller circuit 400 for controlling an input/output pad and pin. A pin 402 is connected to an input/output pad 404. The input/output pad 304 may provide via the pin 402 a controlled digital/CMOS input path, a CMOS/digital output path, an uncontrolled analog path, a controlled analog path, or weak pulls. Two different CPUs, 406A and 406B, have dedicated analog and digital functions added as pad control sources via first level owner I/O multiplexers 408A and 408B. A second level pad ownership multiplexer 410 has additional pad control sources added to it that allows for different control sources to configure the input/output pad 404. In the embodiment shown in FIG. 4, the microcontroller circuit 400 comprises a configurable logic function 414 and an analog input function 416. The flash configuration logic 412 may allow the second level pad ownership multiplexer 410 to grant pin ownership to any one of CPU 406A, CPU 406B, configurable logic function 414, and analog input function 416. In the embodiment shown in FIG. 4, the microcontroller circuit 400 comprises a third level multiplexer 418 controlled by a flash configuration logic 422 that determines the source that configures the pin ownership. The third level multiplexer 418 may assign ownership control to an outside safe/secure control source 420, for example, a Hardware Security Module, a Functional Safety Controller, without limitation. If the second level pad ownership multiplexer 410 to grants exclusive pin ownership to the configurable logic function 414 and the configurable logic function 414 exclusively configures the pin 302 as a digital ST input buffer, no non-owner can override this exclusive configuration. If the second level pad ownership multiplexer 410 to grants exclusive pin ownership to the analog input function 416 and the analog input function 416 exclusively configures the input/output pad 404 so that all digital buffers on the pin 402 are disabled and a certain analog pass switch is enabled, then no non-owner can override this exclusive configuration. If the second level pad ownership multiplexer 410 grants exclusive pin ownership to the third level multiplexer 418 controlled by the flash configuration logic 422 and the third level multiplexer 418 grants exclusive pin ownership to an outside safe/secure control source 420, and the outside safe/secure control source 420 exclusively configures the pin 302, no non-owner can override this exclusive configuration.

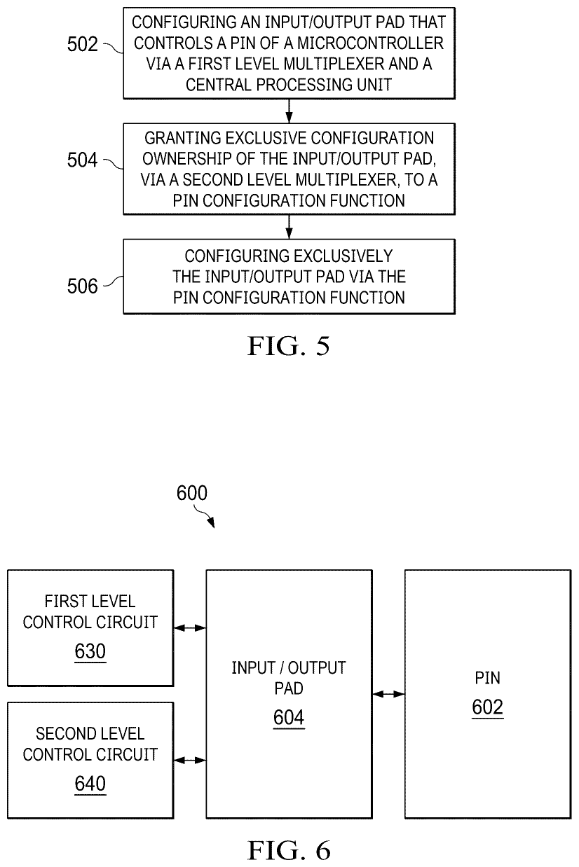

FIG. 5 shows a flow chart of a method to assign an owner of the I/O pin exclusive control of the output state of the pin. An input/output pad that controls a pin of a microcontroller is configured 502 via a first level multiplexer and a central processing unit. Exclusive configuration ownership of the input/output pad is granted 504, via a second level multiplexer, to a pin configuration function. The input/output pad is configured exclusively 506 via the pin configuration function.

The method may provide a MCU power up reset function, a Flash configuration load to permanently assign function to the I/O pad, and a function to start CPU code execution. The Flash configuration load happens before the CPU is allowed to execute any code, so as to make the assignment permanent and outside of CPU control.

FIG. 6 shows a block diagram of a microcontroller 600 comprising: an input/output pad 602; a pin controlled by the input/output pad 604; a first level control circuit to configure the input/output pad 630; and a second level control circuit to exclusively configure the input/output pad 640. The first level control circuit 630 and second level control circuit 640 may be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. The first level control circuit 630 and second level control circuit 640 of FIG. 6 may be implemented by instructions for execution by a processor through, for example, a function, application programming interface (API) call, script, program, compiled code, interpreted code, binary, executable, executable file, firmware, object file, container, assembly code, or object. For example, the first level control circuit 630 and second level control circuit 640 may be implemented by instructions stored in a non-transitory medium such as a memory that, when loaded and executed by a processor such as a CPU (or any other suitable process), cause the functionality of the first level control circuit 630 and second level control circuit 640 described herein.

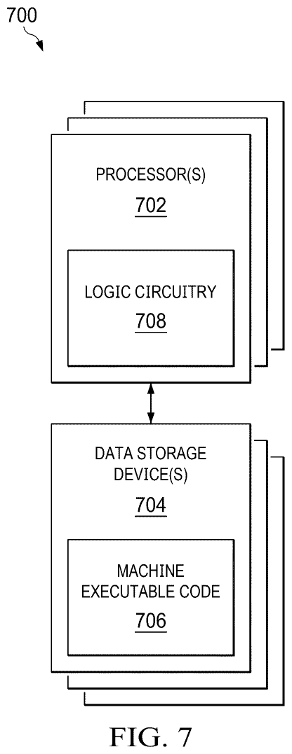

FIG. 7 is a block diagram of circuitry 700 that, in some aspects, may be used to implement various functions, operations, acts, processes, and/or methods disclosed herein. The circuitry 700 includes one or more processors 702 (sometimes referred to herein as “processors 702”) operably coupled to one or more data storage devices (sometimes referred to herein as “storage 704”). The storage 704 includes machine executable code 706 stored thereon and the processors 702 include logic circuitry 708. The machine executable code 706 includes information describing functional elements that may be implemented by (e.g., performed by) the logic circuitry 708. The logic circuitry 708 is adapted to implement (e.g., perform) the functional elements described by the machine executable code 706. The circuitry 700, when executing the functional elements described by the machine executable code 706, may be considered as specific purpose hardware configured for carrying out functional elements disclosed herein. In some aspects the processors 702 may perform the functional elements described by the machine executable code 706 sequentially, concurrently (e.g., on one or more different hardware platforms), or in one or more parallel process streams.

When implemented by logic circuitry 708 of the processors 702, the machine executable code 706 adapts the processors 702 to perform operations of aspects disclosed herein. For example, the machine executable code 706 may adapt the processors 702 to perform at least a portion or a totality of the method to assign an owner of the I/O pin exclusive control of the output state of the pin of FIG. 5. As another example, the machine executable code 706 may adapt the processors 702 to perform at least a portion or a totality of the operations discussed for the second level pad ownership multiplexer 110 and flash configuration logic 112 of FIG. 1, the second level pad ownership multiplexer 210 and flash configuration logic 212 of FIG. 2, the second level pad ownership multiplexer 310 and flash configuration logic 312 of FIG. 3, and the second level pad ownership multiplexer 410 and flash configuration logic 412 of FIG. 4. As a further example, the machine executable code 706 may adapt the processors 702 to perform at least a portion or a totality of the operations discussed for the third level multiplexer 418 controlled by the flash configuration logic 422 of FIG. 4. As a specific, non-limiting example, the machine executable code 706 may adapt the processors 702 to perform at least a portion of the first level control circuit 630 and second level control circuit 640 of FIG. 6. As a specific, non-limiting example, the machine executable code 706 may adapt the processors 702 to perform at least a portion of the pin configuration operations discussed herein.

The processors 702 may include a general purpose processor, a specific purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a specific-purpose computer while the general-purpose computer is configured to execute functional elements corresponding to the machine executable code 706 (e.g., software code, firmware code, hardware descriptions) related to aspects of the present disclosure. It is noted that a general-purpose processor (may also be referred to herein as a host processor or simply a host) may be a microprocessor, but in the alternative, the processors 702 may include any conventional processor, controller, microcontroller, or state machine. The processors 702 may also be implemented as a combination of computing devices, such as a combination of a DSP and a microprocessor, a plurality of microprocessors, one or more microprocessors in conjunction with a DSP core, or any other such configuration.

In some aspects the storage 704 includes volatile data storage (e.g., random-access memory (RAM)), non-volatile data storage (e.g., Flash memory, a hard disc drive, a solid state drive, erasable programmable read-only memory (EPROM), without limitation). In some aspects the processors 702 and the storage 704 may be implemented into a single device (e.g., a semiconductor device product, a system on chip (SOC), without limitation). In some aspects the processors 702 and the storage 704 may be implemented into separate devices.

In some aspects the machine executable code 706 may include computer-readable instructions (e.g., software code, firmware code). By way of non-limiting example, the computer-readable instructions may be stored by the storage 704, accessed directly by the processors 702, and executed by the processors 702 using at least the logic circuitry 708. Also by way of non-limiting example, the computer-readable instructions may be stored on the storage 704, transferred to a memory device (not shown) for execution, and executed by the processors 702 using at least the logic circuitry 708. Accordingly, in some aspects the logic circuitry 708 includes electrically configurable logic circuitry 708.

In some aspects the machine executable code 706 may describe hardware (e.g., circuitry) to be implemented in the logic circuitry 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some aspects, the machine executable code 706 may include an HDL, an RTL, a GL description, a mask level description, other hardware description, or any combination thereof.

In aspects where the machine executable code 706 includes a hardware description (at any level of abstraction), a system (not shown, but including the storage 704) may be configured to implement the hardware description described by the machine executable code 706. By way of non-limiting example, the processors 702 may include a programmable logic device (e.g., an FPGA or a PLC) and the logic circuitry 708 may be electrically controlled to implement circuitry corresponding to the hardware description into the logic circuitry 708. Also, by way of non-limiting example, the logic circuitry 708 may include hard-wired logic manufactured by a manufacturing system (not shown, but including the storage 704) according to the hardware description of the machine executable code 706.

Regardless of whether the machine executable code 706 includes computer-readable instructions or a hardware description, the logic circuitry 708 is adapted to perform the functional elements described by the machine executable code 706 when implementing the functional elements of the machine executable code 706. It is noted that although a hardware description may not directly describe functional elements, a hardware description indirectly describes functional elements that the hardware elements described by the hardware description are capable of performing.

Although examples have been described above, other variations and examples may be made from this disclosure without departing from the spirit and scope of these disclosed examples.

1. A method comprising:
configuring an input/output pad that controls a pin of a microcontroller via a first level multiplexer and a central processing unit;
granting exclusive configuration ownership of the input/output pad, via a second level multiplexer, to a pin configuration function; and
configuring exclusively the input/output pad via the pin configuration function.

2. The method of claim 1, wherein the pin configuration function comprises a logic function, wherein the logic function is configurable or fixed.

3. The method of claim 1, wherein the pin configuration function comprises an analog function.

4. The method of claim 1, comprising controlling the second level multiplexer via flash configuration logic.

5. The method of claim 1, comprising:
granting exclusive configuration ownership of the input/output pad, via the second level multiplexer, to a third level multiplexer;
granting exclusive configuration ownership of the input/output pad, via the third level multiplexer, to an outside safe/secure control source; and
configuring exclusively the input/output pad via the outside safe/secure control source.

6. The method of claim 5, wherein the outside safe/secure control source comprises a Hardware Security Module.

7. The method of claim 5, wherein the outside safe/secure control source comprises a Functional Safety Controller.

8. A device comprising:
a microcontroller comprising a central processing unit, an input/output pad, and a pin controlled by the input/output pad;
a first level multiplexer associated with the central processing unit to configure the input/output pad;
a pin configuration function to exclusively configure the input/output pad; and
a second level multiplexer to assign configuration ownership of the input/output pad to either the first level multiplexer or the pin configuration function.

9. The device of claim 8, wherein the pin configuration function comprises a logic function, wherein the logic function is configurable or fixed.

10. The device of claim 8, wherein the pin configuration function comprises an analog function.

11. The device of claim 8, comprising a flash configuration logic to control the second level multiplexer.

12. The device of claim 8, comprising a third level multiplexer and an outside safe/secure control source, wherein the second level multiplexer is to grant exclusive configuration ownership of the input/output pad to the third level multiplexer, wherein the third level multiplexer is to grant exclusive configuration ownership of the input/output pad to the outside safe/secure control source, and wherein the outside safe/secure control source is to exclusively configure the input/output pad.

13. The device of claim 12, wherein the outside safe/secure control source comprises a Hardware Security Module.

14. The device of claim 12, wherein the outside safe/secure control source comprises a Functional Safety Controller.

15. A microcontroller comprising:
an input/output pad;
a pin controlled by the input/output pad;
a first level control circuit to configure the input/output pad; and
a second level control circuit to exclusively configure the input/output pad.

16. The microcontroller of claim 15, wherein the second level control circuit comprises a logic function or an analog function, wherein the logic function is configurable or fixed.

17. The microcontroller of claim 15, wherein the second level control circuit comprises: a second level multiplexer; and a flash configuration logic to control the second level multiplexer.

18. The microcontroller of claim 15, comprising a third level control circuit to exclusively configure the input/output pad when the second level control circuit grants to the third level control circuit exclusive control ownership of the input/output pad.

19. The microcontroller of claim 18, wherein the third level control circuit comprises a third level multiplexer, flash configuration logic, and an outside safe/secure control source, and wherein the outside safe/secure control source is to exclusively configure the input/output pad.

20. The microcontroller of claim 19, wherein the outside safe/secure control source comprises a Hardware Security Module or a Functional Safety Controller.
